(19) United States
(12) Patent Application Publication
(10) Pub. No.: US 2026/0318430 A1
(43) Pub. Date: Oct. 15, 2026

(54) ROTATING MULTIPORT VALVE

(71) Applicant: MOLDTECS-01-2022 GMBH, Bad Harzburg (DE)

(72) Inventors: Sébastien LARDEUX, Saint Quen Des Toits (FR); Gwenael FOULBOEUF, Entrammes (FR); Stéphane WARNERY, L'Huisserie (FR); Tony MANZELLA, Laval (FR); Xavier BADIBANGA, Rennes (FR)

(21) Appl. No.: 19/481,027

(22) PCT Filed: May 15, 2024
(86) PCT No.: PCT/EP2024/063344

§ 371 Date: Nov. 3, 2025

(30) Foreign Application Priority Data
May 16, 2023 (EP) 23173711.5

(51) Int. Cl. F16K 11/083; F01P 3/20; F01P 5/02; F01P 7/14; F16K 31/524; H01M 8/04029; H01M 8/04746; H01M 10/613; H01M 10/6568

(52) U.S. Cl. CPC F16K 11/0833; F01P 3/20; F01P 5/02; F01P 7/14; F16K 31/52466; H01M 8/04029; H01M 8/04768; H01M 10/613; H01M 10/6568; F01P 2007/146; H01M 2220/20; H01M 2250/20

(57) ABSTRACT

A multiport valve module system for fluids, including an at least four-way valve housing, having a central axis X, which encloses a working chamber having an inner housing surface and having at least four ports. The system has a valve body which is placed in the working chamber and being rotatable about the central axis X and being translatable in direction of the central axis X and having an outer valve surface. The valve body has at least two separate channels with plurality of openings on the outer valve surface for connecting two ports. A torque on the drive shaft is permanently transferred to the valve body such that the valve body rotates synchronously with the drive shaft when the drive shaft is driven by a drive and cams are provided at the valve body and at the valve housing, which cause a translational movement of the valve body in axial direction.

### FIELD OF THE INVENTION

The invention relates to a multiport valve module system for fluids, especially liquids, comprising an at least four-way valve housing, having a central axis X, which encloses a working chamber having an inner housing surface and having at least four ports for supplying and/or discharging a medium into or out of the working chamber. The multiport valve includes also a cover assembled to the valve housing for sealing the working chamber. The module system includes a valve body placed in the working chamber and being rotatable about the central axis X and being translatable in direction of the central axis X and having an outer valve surface. The valve body has at least two separate channels, each channel with two openings on the outer valve surface. Furthermore, a separate drive shaft for connecting a drive with the valve body with the drive shaft guided through the cover is part of the multiport valve module system.

### BACKGROUND OF THE INVENTION

A generic rotatable four-way valve for fluids is already known from EP 3109522 A1, closest prior art, in which a torque of the drive shaft is transmitted to the valve body via two driving discs that can be rotated with backlash relative to each other. According to US 2013/0292593 A1, the translatory movement of the valve body is initiated by a planetary gear. GB 2 609 634 A describes a medical three-way valve for air, which has a valve body with a single channel. The open position is caused by the cams and the biasing element is causing the connected position. The valve body and drive shaft form a one-piece component. According to GB 2 186 951 A, a one-way valve for gases is known in which a translational movement of the valve body caused by a cam is only achieved for the locked position, without a connection of the ports. The only one cam is an additional component. A connected position of the channel with the ports caused by the cam is not provided.

### SUMMARY OF THE INVENTION

It is an object of the present invention to design and arrange a rotatable multiport valve module system for fluids with a few and simple bearing components and in such a way that a fast and precise switching is ensured.

According to an aspect of the invention, the object is achieved by permanently transferring a torque on the drive shaft to the valve body such that the valve body rotates synchronously with the drive shaft when the drive shaft is driven by a drive. In addition to that permanent transmission cams are provided at the valve body and at the valve housing, which cause a translational movement of the valve body in direction of the central axis X synchronously with the rotation for connecting the ports. For generic valves for fluids a main aspect is, that the cams cause the translational movement of the valve body into the closed and connected position of the valve body. The closed position is the position for a tight connection of the ports with the channels. The closed position is to adjust precise and fast without dynamic delays. A movement into the closed position caused by the force of a spring element would have the disadvantage of dynamic delays and an inaccurate sealing. This applies in particular to valves that are used for liquids. When the valve body is lowered into the closed position, a certain volume of the fluid in the valve is displaced in the space below the valve body, between the housing and the valve body. At the same time, the space is closed by the lowering valve body. In the case of liquids, resistance to the lowering of the valve body arises in the form of dynamic overpressure. As liquids are not compressible, dynamic pressures are a significant disadvantage, particularly with fast-switching valves, with regard to precise switching. This disadvantage can be compensated for by the direct drive of the valve body by the cams. The separate drive shaft allows the movement of the valve body not to be transferred to the drive shaft, eliminating the need for a movable bearing for the connection of the drive.

The permanent torque is directly transferred from the drive shaft to the valve body to ensure that the translational movement of the valve body takes place simultaneously with the initiation of the rotary movement. Permanent drive and direct drive are best achieved by connecting the drive shaft and the valve body free from backslash or by forming the drive shaft and the valve body into a one-piece component. By lifting the valve body directly from the rotation of the drive shaft, the friction between the inner housing surface and the outer valve surface or sealings is reduced from the beginning of the rotation, so that in addition to a fast switching of the valve body, less force is required. For the permanent drive the drive shaft is directly form-fittingly and/or frictionally coupled to the valve body. The direct transmission of a torque ensures that the rotation of the shaft has the same speed as the rotation of the valve body. There is no transmission, so that the transmission of the two rotary movements of the drive shaft and the valve body is 1:1.

The valve housing can have a complex structure forming several working chambers, into each of which a valve body can be inserted. The design according to the invention forms a modular system that allows valve bodies being replaced as required. The wording of a plurality of openings on the outer valve surface conceptually summarises the inlet and outlet openings of each channel in the valve body. The axial direction, the radial direction and the coaxial positions have a meaning in relation to the central axis X. Rotationally symmetric includes at least partially rotationally symmetric, likewise conical or spherical also includes at least partially conical or spherical.

According to a further aspect of the invention, the valve body having a sliding surface and the valve housing having a bearing surface and the valve body can be preloaded and placed in the axial direction with the sliding surface against the bearing surface, wherein the bearing surface and/or the sliding surface form a cam profile in the circumferential direction with the cams that extend in axial direction. To provide a simple construction the sliding surface with the cams is integrated in the shape of the valve body and the bearing surface with the cams is integrated in the shape of the valve housing. The valve housing and the valve body are preferably made of a non-abrasive material which, depending on the medium for which the valve is used, has very good sliding properties and is largely free of wear. Plastics are very well suitable for this. The cams engage with each other in the circumferential direction with essentially free from backlash.

The cams are designed and arranged in such a way that a rotation of the valve body about the central axis X necessarily causes a translational movement of the valve body in the axial direction. The valve body and the valve housing each have cams. The valve body and the valve housing each form a one-piece and material-identical component with the cams. For the translational movement there are two significant effects to be distinguished. The downward movement of the valve body into a closed position is directly caused by the cams and the upward movement of the valve body into an open position directly is caused by the spring element.

According to another aspect of the invention, limit stops are provided in the housing in order to directly limit the rotational movement of the valve body by a certain amount. For precise switching of the valve body it is important, that the stops are located directly between the valve body and the housing. This allows the backlash that inevitably occurs within the tolerance to be minimized.

It is important, that the housing surface and the outer valve surface have at least in part a rotationally symmetrical, preferably a conical or a spherical geometry, such that the two surfaces can be pressed against each other in axial direction. The separation of the two surfaces by the translational movement is best achieved by conical geometries, because due to such a geometry the gap between the housing surface and the outer valve surface opens uniformly over the entire surfaces. This is not the situation with a spherical geometry. Depending on the properties of the chosen plastic and the force with which the valve body is preloaded against the valve housing, the ports in the housing can be sealed with the openings without an additional gasket.

According to some embodiments, a sealing is provided between the outer valve surface and the housing surface. That sealing ensures to seal the openings against the ports. This sealing can be achieved by individual sealings or by overmolding the outer valve surface and/or the housing surface locally around the respective opening or port with any sealing material. It is also an alternative to provide this sealing by overmolding the outer valve surface and/or the housing surface entirely with sealing material. Preferably the sealings are assembled around the circumference of the openings or the ports and between the outer valve surface and the housing surface. The respective opening in the valve body is sealed with a sealing against the corresponding port in the housing.

According to some special embodiments, the sealing is designed as a resilient element by means of which the valve body can be preloaded against the housing. The elasticity and geometry of these sealings is such that no separate spring element is necessary to preload the valve body against the housing. Rubber sealings are preferred for this purpose. The more obtuse the angle of a conical shape, the greater the force of the sealings in the direction of the central axis X.

According to some embodiments, the cover having a hole having an inner surface, the inner surface being designed to seal the drive shaft and the working chamber and to pivot the valve body, whereby the drive shaft having a flange casting on the cover in one axial direction and whereby the drive shaft can be pulled out of the cover in the other, opposite axial direction. The flange makes it possible to pull out the drive shaft together with the drive at any time. The inner surface having for example a cylindrical or a coaxial shape and provides two different functions. The drive shaft is sealed with respect to the cover by means of a gasket placed in the hole. The stem of the valve body is pivoted on the inner surface of the hole.

According to some embodiments, a spring element is assembled between the valve housing and the valve body, by means of which the valve body can be preloaded in axial direction against the housing. The spring element is designed as a spring washer or as a coil spring and is assembled substantially coaxially with the stud. Regarding the valve body, the spring element and the cams are arranged on opposite sides of the valve body. The spring element can be assembled on the lower side, the narrower side of the valve body.

In this embodiment, which is also described in more detail in the figures, the sealings are decompressed by the spring element and are compressed by the cams.

According to an important embodiment, the valve body having a lower stud, which is formed coaxially with the central axis X and is assembled in a recess in the valve housing. The stud is used to pivot the valve body in the lower part of the housing. The stud is positioned above the conical part of the valve body.

According to an important further embodiment, the valve body has a stem formed coaxially with the central axis X, whereby the drive shaft is guided in the stem and the stem is directly swivel-mounted in radial direction in a hole of the cover. The stem is used to bear the upper part of the valve body in the valve housing in the radial direction and for bearing or guiding the translational movement of the valve body. The stem is positioned above the conical part of the valve body. The radial mounting of the valve body with the stem and the stud ensures that the valve body is precisely mounted in the axial direction in any position. When the valve body is opened, a gap is generated between the valve body and the housing, so that the valve body is not supported over the conical surface in the radial direction. This bearing is achieved by the stem and the stud, both of which are in direct contact with the valve housing.

According to some embodiments, the stem has a receptacle in which the drive shaft is coupled with a torque proof connection to the valve body and sliding mounted in axial direction. The receptacle has the shape of a prismatic cavity to transfer the torque in the circumferential direction from the drive shaft to the valve body. The two-part embodiment allows the translational movement of the valve body along the central axis X being independent from the drive shaft. The drive shaft is not moving in axial direction.

According to a preferred embodiment, a rotatable multiport valve module system comprising exclusively the following components:
1. a valve housing with a working chamber having a housing surface with its own cam structure;
2. a cover as part of the valve housing for closing the working chamber;
3. a valve body with its own cam structure and with an outer valve surface;
4. a drive shaft which is guided through the cover to rotate the valve body;
5. a spring element by means of which the valve body can be preloaded against the valve housing;
6. a gasket arranged between the drive shaft and the housing;
7. a plurality of sealings arranged between the housing surface and the outer valve surface.

The cams are integrated in the respective component for the housing and the valve body. The housing and the body, each is produced with the cam structure in one molding process. The cams slide on each other due to the pre-load of the spring element. The permanent torque is directly transferred from the drive shaft to the valve body to ensure that the translational movement of the valve body takes place simultaneously with the initiation of the rotary movement. By lifting the valve body directly from the rotation of the drive shaft, the friction between the inner housing surface and the outer valve surface or sealings is reduced from the beginning of the rotation, so that in addition to a fast switching of the valve body less force is required. Preferably the outer conical valve surface and the housing surface have a conical or spherical geometry. For a torque a torque proof connection between drive shaft and the valve body is realized with a non-rotatably coupling or a positive locking.

It is further object of the present invention to provide a system consisting of a rotating multiport valve module system and of one or more components of a cooling system for a Battery Electric Vehicle or a Fuel Cell Electric Vehicle or any other cooling system for vehicles or for machines or for engines, in particular comprising a pump, a cooler and tube connections between said components.

It is further object of the present invention to provide a method for moving a rotating multiport valve module system comprising a valve body with an outer valve surface and a valve housing with a working chamber having a housing surface, said working chamber being closable by a cover and the valve body being able to be preloaded against the valve housing, characterized in that the valve body and the valve housing are designed each having integral cam profiles which slide on each other in the circumferential direction about an axis X such that, by the valve body being rotated about an axis X, the valve body is simultaneously in translational movement in the direction of the central axis X. Preferably the outer valve surface and the housing surface have a conical or spherical geometry.

### BRIEF DESCRIPTION OF THE DRAWINGS

Various aspects of the invention, including its features and advantages, will be readily understood from the example embodiments discussed in the following detailed description and the accompanying drawings, in which:

FIG. 1 illustrates an exploded view drawing of a multiport valve module system;

FIG. 2 illustrates a perspective view on the valve body and the cover;

FIG. 3a illustrates a sectional view of a closed valve;

FIG. 3b illustrates a sectional view of an open valve;

FIG. 4a illustrates a sectional view of a 4-way-valve in a first position;

FIG. 4b illustrates a sectional view of a 4-way-valve in a second position;

FIG. 5 illustrates a diagram of the movements of the valve body compared to the drive shaft during a rotation of 90 degrees.

### DETAILED DESCRIPTION OF THE INVENTION

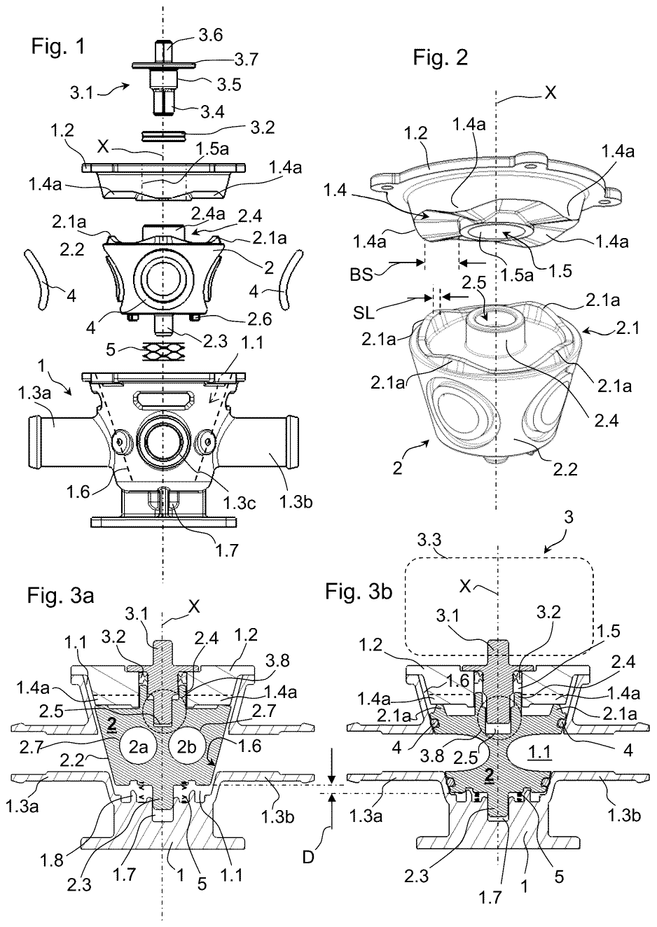

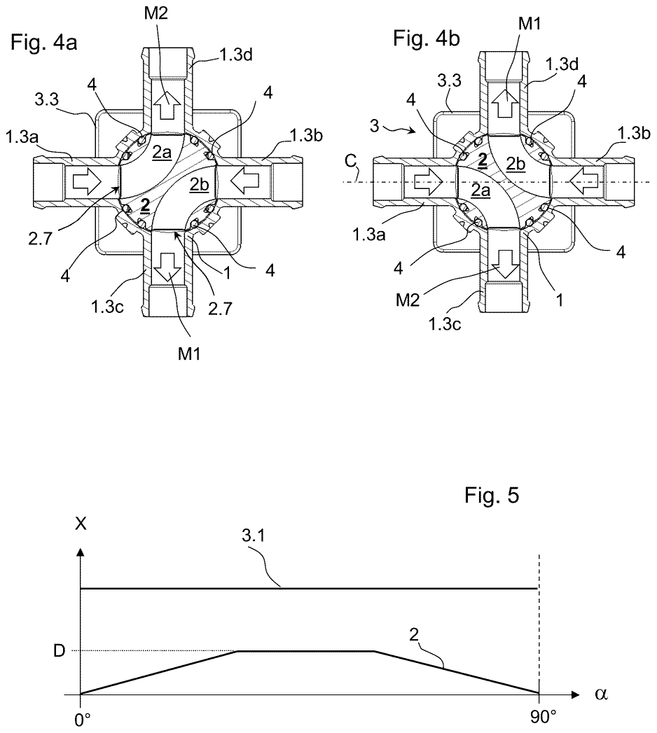

FIGS. 1 to 4b illustrate the same embodiments of a multiport valve module system comprising a valve housing 1 with a cover 1.2 for closing a working chamber 1.1 inside of the valve housing 1. The cover 1.2 is part of the valve housing 1. The multiport valve module system comprises also a valve body 2 located in the working chamber 1.1. The valve body 2 is driven around an axis X by a drive 3 with a motor 3.3 and a separate drive shaft 3.1. The working chamber 1.1 having an inner housing surface 1.6 and a plurality of ports 1.3a-1.3d for supplying and/or discharging mediums M1, M2 (FIGS. 4a, 4b) into or out of the working chamber 1.1. The housing surface 1.6 having a conical shape which is parallel to a conical outer surface 2.2 of the valve body 2.

The ports 1.3a-1.3d are designed as nozzles onto which, for example, a hose or a plastic tube can be plugged. As illustrated in FIGS. 4a and 4b the valve housing 1 having four ports 1.3a-1.3d, whereby two ports 1.3a-1.3d can be connected to each other through a respective channel 2a, 2b in the valve body 2. Each channel 2a, 2b having two openings 2.7 on the outer valve surface 2.2. The medium M1, M2 flows into and out of the channels 2a, 2b through the openings 2.7. The connection between the channels 2a, 2b and the ports 1.3a-1.3d is tight and defines the closed position of the valve body 2. The valve body 2 is moving downwards into closed position and from the closed position upwards into the open position.

The FIGS. 4a and 4b show two different switching positions of the valve body 2. According to FIG. 4a the medium M1 is flowing into port 1.3b, through the channel 2b and out of port 1.3c. In the illustration according to FIG. 4b, the valve body 2 is shown rotated 90° to the right compared to the illustration according to FIG. 4a. Here the medium M1 flows also into port 1.3b, through the channel 2b but out of port 1.3d. The situation is similar with port 1.3a. Here the medium M2 flows according to FIG. 4a within the channel 2a and out of port 1.3d. According to FIG. 4b the medium M2 flows out of port 1.3c.

Each of the respective openings 2.7 in the valve body 2 is sealed with a sealing 4 against the corresponding port 1.3a-1.3d in the valve housing 1. The sealings 4 are assembled around the circumference of the openings 2.7 at the valve body 2 and located between the outer valve surface 2.2 and the housing surface 1.6. The sealings 4 are also shown, for example, in the sectional view according to FIG. 3b. This sectional view corresponds to cross-section according to the cutting line C of FIG. 4b.

According to a further, not shown embodiment, the multiport valve module system having no such sealings 4 assembled around the circumference of the openings 2.7 at the valve body 2. The seal between the valve body 2 and the valve housing 1 is achieved by precisely profiled surfaces of the housing surface 1.6 and the outer surface 2.2.

According to other, not shown embodiments, the multiport valve module system can also have more than four ports. For that several valve housings with one valve body each can be arranged one behind the other in the direction of the central axis X. All valve bodies are torque proof connected to the drive shaft, so that they rotate synchronously to each other and to the drive shaft.

As illustrated in FIG. 2 the valve body 2 having a sliding surface 2.1 and the valve housing 1 having a bearing surface 1.4 to generate a translational movement of the valve body 2. The sliding surface 2.1 and the bearing surface 1.4 each form a cam profile in the circumferential direction with the cams 1.4a, 2.1a extending in the axial direction. The sliding surface 2.1 has a width SL in the radial direction which corresponds to 20% of the width BS in the radial direction of the bearing surface 1.4. The reduced width limits the frictional resistance between the cams. The cams 1.4a, 2.1a engage with each other in the circumferential direction with essentially free from backlash. To provide a simple construction the cams 2.1a with the sliding surface 2.1 are integrated in the valve body 2 and cams 1.4a with the bearing surface 1.4 are integrated in the valve housing 1. The valve housing 1 and the valve body 2 are preferably made of a non-abrasive material which, depending on the medium for which the valve is used, having very good sliding properties and is largely free of wear. Plastics are very well suitable for this.

The valve body 2 is preloaded by a spring element 5 in the axial direction with the sliding surface 2.1 against the bearing surface 1.4. Following the construction in view of the invention, the spring element 5 is assembled opposite to the cams 1.4a, 2.1a on the other side of the valve body 2. This construction ensures that a rotation of the valve body 2 about the central axis X necessarily causes a translational movement of the valve body 2 in the axial direction. Depending on the geometry of the cams 1.4a, 2.1a and due to the preload caused by the spring element 5, the valve body 2 is moved alternately in the direction of the central axis X in the valve housing 1. It is important, that the downward movement of the valve body 2 into the closed position is directly caused by the cams 1.4a, 2.1a and the upward movement of the valve body 2 into an open position directly and only is caused by the spring element 5.

According to the illustrated example the spring element 5 is assembled at the bottom of the working chamber 1.1 between the valve body 2 and the valve housing 1. The spring element 5 is assembled on the lower side, the narrower side of the valve body. As illustrated in FIG. 3 a collar 1.8 is provided to guide the spring element 5. In the example shown, the spring element 5 presses the valve body 2 upwards against the valve housing 1. The downward movement of the valve body 2 is caused directly by the cams 1.4a, 2.1a and the upward movement is directly caused by the spring element 5. This having the effect that the decompression of the sealings 4 is supported by the spring element 5. The more difficult compression of the sealings 4 is made directly by the cams 1.4a, 2.1a. The force that is necessary for the compression is provided by the drive (FIG. 3b). A compression of the sealings 4 with the force of the spring elements 5 would cause dynamic delays. The geometry of the cams 1.4a, 2.1a is selected in such a way that the valve body 2, starting from a closed position, lifts completely during a 90° rotation and lowers again into the closed position. The movement of the valve body 2 is shown in FIG. 5. The cams 1.4a, 2.1a generate a movement of the valve body 2 in the direction of the central axis X by a distance D shown in FIGS. 3a and 3b. The drive shaft 3.1 does not make a translational movement during any rotation.

The basic principle of the invention is that by lifting the valve body 2 from the rotation of the drive shaft 3.1 the friction between the housing surface 1.6 of the valve housing 1 and the outer surface 2.2 of the valve body 2 or the sealings 4 is reduced from the beginning of the rotation, so that in addition to a fast switching of the valve body 2, less force is required. This advantage is especially significant when no sealings 4 are provided. In this case the friction to be overcome between the outer surface 2.2 and the housing surface 1.6 is considerably greater than the friction between the sealings 4 and the housing surface 1.6. The effect to reduce the friction with starting the rotation becomes possible due to the conical geometry or any similar geometry like spherical. As also shown in FIGS. 3a and 3b, the conical housing surface 1.6 of the valve housing 1 and the outer surface 2.2 of the valve body 2 are parallel to each other. Through any translational movement of the valve body in the direction of the central axis X, the distance between the two surfaces 1.6, 2.2 is varied in radial direction to the central axis X.

To drive the valve body 2 the drive shaft 3.1 is performed through a hole 1.5 in the cover 1.2. The hole 1.5 having an inner surface 1.5a which is designed to seal the drive shaft 3.1 and to pivote the valve body 2. For sealing the drive shaft 3.1 a gasket 3.2 is assembled between the drive shaft 3.1 and the inner surface 1.5a. The gasket 3.2 is sealing a gasketing surface 3.5 of the drive shaft 3.1 with an inner surface 1.5a of the hole 1.5.

The valve body 2 and the separate drive shaft 3.1 are constructed in two parts. The valve body 2 having a stem 2.4 which having a prismatic receptacle 2.5 in which the drive shaft 3.1 is pivoted and coupled with a torque proof connection 3.8 and free from backslash to the valve body 2. For that coupling the drive shaft 3.1 having a pin 3.4 having a hexagonal cross-section coupled to a corresponding cross-section in the receptacle 2.5. Such a connection only in circumferential direction provides, that the translational movement of valve body 2 is not transferred to the drive shaft 3.1.

For the movement of the valve body 2 the rotation is transferred from an electric drive 3 to the drive shaft 3.1 and from the drive shaft 3.1 to the valve body 2. The drive shaft 3.1 having a drive pin 3.6 for a rotary joint with the drive 3. The valve body 2 rotates synchronously with the drive shaft 3.1 when the drive shaft is driven by the drive. To achieve a synchronous rotation a permanent torque is directly transferred from the drive shaft 3.1 to the valve body 2 to ensure that the translational movement of the valve body 2 takes place simultaneously with the initiation of the rotary movement of the drive. The valve body 2 moves relative to the drive shaft 3.1 in the direction of axis X, which is why the coupling using the pin 3.4 and a torque proof connection 3.8 are designed as a sliding connection in direction of axis X. For keeping the drive shaft 3.1 in a stationary position in one of both axial directions, the drive shaft 3.1 having a shoulder 3.7. The drive shaft 3.1 is not secured against being pulled out of the cover 1.2 and can be replaced at any time together with a drive (FIG. 3b).

At the top the valve body 2 is pivoted by a stem 2.4. For this purpose, the stem 2.4 having a bearing surface 2.4a, over which the valve body 2 is pivoted in the hole 1.5. At the bottom, the valve body 2 having a stud 2.3, over which it is pivoted in a recess 1.7 of the valve housing 1. Limit stops 2.6 are provided around the stud 2.3 in order to limit the rotational movement of the valve body 2 by a certain amount, for example more than 180°.

What is claimed is:

1. A multiport valve module system for fluids, especially liquids, comprising:
a) an at least four-way valve housing, having a central axis X, which encloses a working chamber having an inner housing surface and having at least four ports for supplying and/or discharging a medium (M1, M2) into or out of the working chamber;
b) the valve housing includes a cover that is assembled to the valve housing for sealing the working chamber;
c) a valve body placed in the working chamber and being rotatable about the central axis X and being translatable in direction of the central axis X and having an outer valve surface;
d) valve body having at least two separate channels each channel with two openings on the outer valve surface for connecting two ports
e) a separate drive shaft for connecting a drive with the valve body with the drive shaft guided through the cover,
wherein
f) a torque on the drive shaft is permanently transferred to the valve body such that the valve body rotates synchronously with the drive shaft when the drive shaft is driven by a drive and
g) cams are provided at the valve body and at the valve housing, which cause a translational movement of the valve body in direction of the central axis X for connecting the ports.

2. The multiport valve module system according to claim 1, wherein the valve body having a sliding surface and the valve housing having a bearing surface and the valve body can be preloaded and placed in the axial direction with the sliding surface against the bearing surface wherein the bearing surface and the sliding surface form a cam profile in the circumferential direction with the cams that extend in axial direction.

3. The multiport valve module system according to claim 1, wherein the cams are designed and arranged in such a way that a rotation of the valve body about the central axis X necessarily causes a translatory movement of the valve body in the axial direction.

4. The multiport valve module system according to claim 1, wherein limit stops are provided in the housing in order to directly limit the rotational movement of the valve body by a certain amount.

5. The multiport valve module system according to claim 1, wherein a sealing is provided between the outer valve surface and the housing surface.

6. The multiport valve module system according to claim 5, wherein the sealing is designed as a resilient element by of which the valve body can be preloaded against the housing.

7. The multiport valve module system according to claim 1, wherein the cover having a hole having an inner surface the inner surface being designed to seal the drive shaft and the working chamber and to pivot the valve body, whereby the drive shaft having a flange casting on the cover in one axial direction and whereby the drive shaft be pulled out of the cover in the other, opposite axial direction.

8. The multiport valve module system according to claim 1, wherein a spring element is provided between the valve housing and the valve body, by which the valve body can be preloaded in axial direction against the housing.

9. The multiport valve module system according to claim 1, wherein the valve body having a lower stud which is formed coaxially with the central axis X and is assembled in a recess in the valve housing.

10. The multiport valve module system according to claim 1, wherein the valve body having a stem formed coaxially with the central axis X, whereby the drive shaft is guided in the stem and the stem is swivel-mounted in radial direction in the cover

11. The multiport valve module system according to claim 10, wherein the stem having a receptacle in which the drive shaft is coupled with a torque proof connection to the valve body and sliding mounted in axial direction.

12. The multiport valve module system according to claim 8, wherein with relation to the valve body, the spring element is arranged opposed to the cams in the axial direction.

13. The multiport valve module system according to claim 2, wherein the sliding surface has a width SL in the radial direction which corresponds to a maximum of 50%, preferably a maximum of 25% and further preferably a maximum of 10% of the width BS in the radial direction of the bearing surface

14. A system, consisting of:
a rotating multiport valve module system according to claim 1 and of one or more components of a cooling system for a Battery Electric Vehicle or a Fuel Cell Electric Vehicle or any other cooling system for vehicles or for machines or for engines,
in particular comprising a pump, a cooler and tube connections between said components.

15. The multiport valve module system according to claim 2, wherein the cams are designed and arranged in such a way that a rotation of the valve body about the central axis X necessarily causes a translatory movement of the valve body in the axial direction, and wherein limit stops are provided in the housing in order to directly limit the rotational movement of the valve body by a certain amount.

16. The multiport valve module system according to claim 15, wherein a sealing is provided between the outer valve surface and the housing surface, and wherein the sealing is designed as a resilient element by which the valve body can be preloaded against the housing.

17. The multiport valve module system according to claim 2, wherein the cover having a hole having an inner surface, the inner surface being designed to seal the drive shaft and the working chamber and to pivot the valve body, whereby the drive shaft having a flange casting on the cover in one axial direction and whereby the drive shaft can be pulled out of the cover in the other, opposite axial direction, and wherein a spring element is provided between the valve housing and the valve body, by which the valve body can be preloaded in axial direction against the housing.

18. The multiport valve module system according to claim 17, wherein the valve body having a lower stud, which is formed coaxially with the central axis X and is assembled in a recess in the valve housing, wherein the valve body having a stem formed coaxially with the central axis X, whereby the drive shaft is guided in the stem and the stem is swivel-mounted in radial direction in the cover, and wherein the stem having a receptacle in which the drive shaft is coupled with a torque proof connection to the valve body and sliding mounted in axial direction.

19. The multiport valve module system according to claim 18, wherein the sliding surface has a width SL in the radial direction which corresponds to a maximum of 50%, preferably a maximum of 25% and further preferably a maximum of 10% of the width BS in the radial direction of the bearing surface.

20. A system, consisting of:
a rotating multiport valve module system according to claim 19 and of one or more components of a cooling system for a Battery Electric Vehicle or a Fuel Cell Electric Vehicle or any other cooling system for vehicles or for machines or for engines,
in particular comprising a pump, a cooler and tube connections between said components.
